(19) United States
(12) Patent Application Publication
(10) Pub. No.: US 2026/0091982 A1
(43) Pub. Date: Apr. 2, 2026

(54) SURFACE-TREATED HOLLOW SILICA AND METHOD FOR PRODUCING SURFACE-TREATED HOLLOW SILICA

(71) Applicants: AGC Inc., Tokyo (JP); AGC SI-TECH CO., LTD., Kitakyushu-shi (JP)

(72) Inventors: Hiromichi KAMO, Tokyo (JP); Shinnosuke ARIMITSU, Tokyo (JP)

(73) Assignees: AGC Inc., Tokyo (JP); AGC SI-TECH CO., LTD., Kitakyushu-shi (JP)

(21) Appl. No.: 19/411,483

(22) Filed: Dec. 8, 2025

Related U.S. Application Data
(63) Continuation of application No. PCT/JP2024/020725, filed on Jun. 6, 2024.

(30) Foreign Application Priority Data
Jun. 16, 2023 (JP) 2023-099441

(51) Int. Cl. C01B 33/18; C08K 3/36; C08K 5/14; C08L 25/10; C08L 71/12

(52) U.S. Cl. CPC C01B 33/18; C08K 3/36; C08K 5/14; C08L 25/10; C08L 71/12; C01P 2006/10; C01P 2006/12; C01P 2006/16

(57) ABSTRACT

Surface-treated hollow silica, having a peak area of an amine in chromatography being 70% or more of a theoretical value, and having a symmetry coefficient S of 8 or less in chromatography. A method for producing the surface-treated hollow silica, the method including: performing a surface treatment on untreated hollow silica, in which a value obtained by dividing a molecular weight of a silane coupling agent used in the surface treatment by the number of Si atoms contained in one molecule of the silane coupling agent is 100 to 300.

### CROSS-REFERENCE TO RELATED APPLICATIONS

This is a continuation of International Application No. PCT/JP2024/020725 filed on Jun. 6, 2024, and claims priority from Japanese Patent Applications No. 2023-099441 filed on Jun. 16, 2023, the entire contents of which are incorporated herein by reference.

### TECHNICAL FIELD

The present invention relates to surface-treated hollow silica and a method for producing surface-treated hollow silica.

### BACKGROUND ART

An electrical insulation layer provided in a printed wiring board requires properties such as a low dielectric constant, a low dielectric loss tangent, and a low linear expansion coefficient. In recent years, resin compositions including a thermosetting resin and silica particles have been used to produce an electrical insulation layer provided in a metal clad laminate that can be processed into a printed wiring board (see Patent Literatures 1 and 2). Specifically, the metal clad laminate in which the semi-cured product of the above resin compositions is laminated as an electrical insulation layer on a surface of a metal substrate layer is used. As another example, a metal clad laminate in which glass cloth or the like impregnated with a resin composition is laminated as an electrical insulation layer on a surface of a metal substrate layer is used. Here, a filler (filling material) is used as a material of a prepreg using a thermosetting resin, and the filler itself typically tends to increase a relative dielectric constant of the obtained prepreg. Among these, a metal clad laminate using a hollow filler can lower the relative dielectric constant compared to that using a solid filler, and therefore is investigated as described in Patent Literatures 1 to 3.

Furthermore, when used in the resin composition, silica that has been surface-treated is used, and is investigated as described in Patent Literature 4.
Patent Literature 1: JP2008-31409A
Patent Literature 2: JP2017-522580A
Patent Literature 3: WO2019/230661
Patent Literature 4: JP6347644B

### SUMMARY OF INVENTION

The inventors have discovered that known surface-treated hollow silica in the related art does not provide sufficient adhesiveness between a resin composition, a semi-cured product thereof, a prepreg, or the like and a substrate made of a metal or the like. The inventors have discovered that if surface treatment conditions are not optimized, a silanol group remains on a silica surface, and peel strength after high-temperature and high-humidity test is significantly reduced.

Therefore, an object of the present invention is to provide surface-treated hollow silica in which excellent adhesiveness to a resin is exhibited when the surface-treated hollow silica is mixed with the resin for use in an electronic application, and the adhesiveness is not significantly reduced even when exposed to a high-temperature and high-humidity environment.

As a result of extensive research, the inventors have discovered that the above problem can be solved by setting a symmetry coefficient S and a peak area of an amine in chromatography of surface-treated hollow silica in specific ranges, leading to the completion of the present invention.

The present invention relates to the following.
(1) Surface-treated hollow silica, having a peak area of an amine in chromatography being 70% or more of a theoretical value, and having a symmetry coefficient S of 8 or less in the chromatography.
(2) The surface-treated hollow silica according to the (1), having a density of 0.25 g/cm³ to 2.00 g/cm³.
(3) The surface-treated hollow silica according to the (1) or (2), having a BET specific surface area of 1 m²/g to 100 m²/g.
(4) The surface-treated hollow silica according to any one of the (1) to (3), having a median diameter (d50) of 0.1 μm to 10 μm.
(5) A method for producing the surface-treated hollow silica according to any one of the (1) to (4), the method including: performing a surface treatment on untreated hollow silica, in which a value obtained by dividing a molecular weight of a silane coupling agent used in the surface treatment by the number of Si atoms contained in one molecule of the silane coupling agent is 100 to 300.
(6) The method for producing the surface-treated hollow silica according to the (5), in which the surface treatment includes bringing the untreated hollow silica into contact with the silane coupling agent, followed by heating at a temperature of 50° C. to 200° C.
(7) The method for producing the surface-treated hollow silica according to the (6), in which a solvent is used during the contact, and a product A×B of a density A of the untreated hollow silica and a solvent charged amount B per gram of the untreated hollow silica is 0.5 to 2.5.
(8) A resin composition including: the surface-treated hollow silica according to any one of the (1) to (4); and a resin.

The present invention can provide surface-treated hollow silica in which excellent adhesiveness to a resin is exhibited when the surface-treated hollow silica is mixed with the resin for use in an electronic application, and there is no significant change in adhesiveness even when exposed to harsh environments.

### DESCRIPTION OF EMBODIMENTS

Hereinafter, the present invention will be described, and the present invention is not limited by examples in the following description. Note that, in the present description, an expression “to” used to express a numerical range includes numerical values before and after it as a lower limit value and an upper limit value of the range, respectively.

### <Surface-treated Hollow Silica>

In surface-treated hollow silica of the present invention, in chromatography of the surface-treated hollow silica, a peak area of an amine is 70% or more of a theoretical value, and a symmetry coefficient S is 8 or less.

Generally, silanol groups (Si—OH) of silica particles are classified into an internal silanol group present within an Si—O network inside the particle, an isolated silanol group which is a silanol group present on a particle surface and not bonded to water adsorbed to the silica particle, and a bonded silanol group bonded to water adsorbed to the silica particle or bonded to silanol on a silica surface. When a surface treatment is performed on the silica particle, these silanol groups react with a surface treatment agent and are substituted with substituents that make silica surfaces more compatible with a resin. In this case, it is found that if raw materials used for the surface treatment and treatment conditions are not properly adjusted, adhesiveness to the resin decreases, and in addition, the adhesiveness to the resin decreases significantly after a high-temperature and high-humidity test.

Therefore, in the surface-treated hollow silica of the present invention, the peak area of an amine in chromatography of the surface-treated hollow silica is 70% or more of the theoretical value, and the symmetry coefficient S is 8 or less in chromatography of the surface-treated hollow silica. When the peak area is 70% or more of the theoretical value and the symmetry coefficient S is 8 or less, it is considered that the silanol groups on the silica particle surface sufficiently react with a silane coupling agent, and the silica surface is sufficiently covered with the silane coupling agent. Therefore, excellent peel strength is obtained, and the silanol group that interacts with an amine is sufficiently deactivated, and the silanol group that interacts with a water molecule when exposed to high-temperature and high-humidity conditions is also deactivated, and thus reduction in peel strength after high-temperature and high-humidity test is prevented. Here, the deactivation refers to a state in which the silanol group reacts with the silane coupling agent and is less likely to interact with the amine.

Since the theoretical value of the peak area is 100%, it is theoretically impossible for the peak area to exceed 100%. The peak area is 70% or more of the theoretical value, preferably 80% or more, more preferably 90% or more, and most preferably 95% or more.

Since a theoretical value of the symmetry coefficient S is at least 1, it is theoretically impossible for the symmetry coefficient S to be less than 1. The symmetry coefficient S is 8 or less, preferably 3 or less, more preferably 2.5 or less, still more preferably 2 or less, and most preferably 1.5 or less.

A method for measuring the above symmetry coefficient and peak area of an amine in chromatography is as follows.

The surface-treated hollow silica is wet-packed into a stainless steel column with an internal diameter of 4.6 mm and a length of 100 mm, and this column is then loaded into a chromatography device (Prominence (manufactured by Shimadzu Corporation)), and measurement is performed under the following conditions.
Eluent: MeOH/20 mM buffer solution of phosphoric acid (pH 7.0)=82/18
Flow rate: 0.5 mL/min
Temperature: 25° C.
Detector: UV at 254 nm
Sample: propranolol hydrochloride
An obtained peak is analyzed according to JIS K0124:2011 to obtain the peak area and the symmetry coefficient. Note that a peak area obtained when the same measurement is performed without packing the surface-treated hollow silica is used as the theoretical value of the peak area.

The symmetry coefficient S and the peak area of an amine in chromatography of the surface-treated hollow silica can be adjusted by a type and an amount of the surface treatment agent, an amount of the solvent used during the surface treatment, a surface treatment temperature, and the like.

From a viewpoint of maintaining strength when dispersed in a resin while lowering a relative dielectric constant and improving the adhesiveness to the resin, a density of the surface-treated hollow silica determined by a constant volume expansion method using argon gas and a dry pycnometer is preferably 0.25 g/cm³ to 2.00 g/cm³, more preferably 0.25 g/cm³ to 1.50 g/cm³, and still more preferably 0.30 g/cm³ to 1.00 g/cm³.

The surface-treated hollow silica of the present invention preferably has a BET specific surface area of 1 m²/g to 100 m²/g. It is substantially difficult to set the BET specific surface area to less than 1 m²/g. When the BET specific surface area is 100 m²/g or less, it is possible to prevent an increase in the viscosity when the surface-treated hollow silica is dispersed in a resin to form a resin composition, and the dispersibility in the resin composition is not deteriorated. The BET specific surface area is preferably 1 m²/g to 100 m²/g, more preferably 1 m²/g to 50 m²/g, still more preferably 1 m²/g to 20 m²/g, and most preferably 1 m²/g to 15 m²/g.

The specific surface area is obtained by a multi-point BET method based on a nitrogen adsorption method using the specific surface area and pore distribution measuring device (for example, “BELSORP-mini HI” manufactured by MicrotracBEL Corp., or “TriStar II” manufactured by Micromeritics Instrument Corporation).

In the surface-treated hollow silica, a median diameter d50, which is a particle diameter at a point where a cumulative volume from a smallest particle size reaches 50% on a volume-based particle size distribution curve, is preferably 0.1 μm to 10 μm.

When the d50 is 0.1 μm or more, an increase in the viscosity of the resin composition obtained by dispersing the surface-treated hollow silica in the resin can be prevented, and a deterioration in the dispersibility of the surface-treated hollow silica in the resin can be prevented. The d50 is more preferably 0.2 μm or more, still more preferably 0.25 μm or more, and particularly preferably 0.3 μm or more. In the case where the d50 is too large, when the resin composition is formed into a film, the film becomes grainy. Therefore, the d50 is preferably 10 μm or less, more preferably 8 μm or less, still more preferably 7 μm or less, particularly preferably 5 μm or less, and most preferably 3 μm or less.

The d50 is a volume-based cumulative 50% diameter obtained by a laser diffraction particle size distribution analyzer (for example, “MT3300EXII” manufactured by MicrotracBEL Corp.). That is, the particle size distribution is measured by a laser diffraction and scattering method, a cumulative curve is obtained from the smallest value by setting a total volume of the surface-treated hollow silica to 100%, and the volume-based cumulative 50% diameter represents a particle diameter at a point on the cumulative curve where the cumulative volume reaches 50%.

The surface-treated hollow silica of the present invention is surface-treated with a silane coupling agent. By surface-treating with a silane coupling agent, which is a surface treatment agent, a strong bond is formed between a functional group of the silane coupling agent and the silanol group, and this bond is not broken when the surface-treated hollow silica is mixed with a resin. The bond is not easily broken by moisture even in a high-temperature and high-humidity environment. Furthermore, by bonding an organic functional group of the silane coupling agent to the silica surface, an amount of silanol groups remained on the surface is reduced, the surface is made hydrophobic, and the affinity with the resin in the resin composition is improved, the dispersibility of the surface-treated hollow silica in the resin and the strength after forming a resin film can be improved, and moisture adsorption can be inhibited to improve a decrease in the peel strength after high-temperature and high-humidity test.

Examples of types of the silane coupling agent include an aminosilane coupling agent, an allylsilane coupling agent, an epoxysilane coupling agent, a mercaptosilane coupling agent, an alkylsilane coupling agent, a fluorine-containing silane coupling agent, and an organosilazane compound. One type of the silane coupling agent may be used or two or more types thereof may be used in combination.

Specifically, examples of the silane coupling agent include an aminosilane coupling agent such as aminopropylmethoxysilane, aminopropyltriethoxysilane, ureidopropyltriethoxysilane, N-phenylaminopropyltrimethoxysilane, and N-(2-aminoethyl)aminopropyltrimethoxysilane; an allylsilane coupling agent such as methyltrimethoxysilane, vinyltrimethoxysilane, octadecyltrimethoxysilane, phenyltrimethoxysilane, metachloroxypropyltrimethoxysilane, imidazole silane, and triazine silane; an epoxysilane coupling agent such as glycidoxypropyltrimethoxysilane, glycidoxypropyltriethoxysilane, glycidoxypropylmethyldiethoxysilane, glycidylbutyltrimethoxysilane, and (3,4-epoxycyclohexyl)ethyltrimethoxysilane; a mercaptosilane coupling agent such as mercaptopropyltrimethoxysilane and mercaptopropyltriethoxysilane; an alkylsilane coupling agent such as methyltrimethoxysilane, ethyltrimethoxysilane, hexyltrimethoxysilane, octyltrimethoxysilane, decyltrimethoxysilanc, octadecyltrimethoxysilane, dimethyldimethoxysilane, and octyltriethoxysilane; a fluorine-containing silane coupling agent such as CF₃(CF₂)₇CH₂CH₂Si(OCH₃)₃, CF₃(CF₂)₇CH₂CH₂SiCl₃, CF₃(CF₂)₇CH₂CH₂Si(CH₃)(OCH₃)₂, CF₃(CF₂)₇CH₂CH₂Si(CH₃)Cl₂, CF₃(CF₂)₅CH₂CH₂SiCl₃, CF₃(CF₂)₅CH₂CH₂Si(OCH₃)₃, CF₃CH₂CH₂SiCl₃, CF₃CH₂CH₂Si(OCH₃)₃, C₈F₁₇SO₂N(C₃H₇)CH₂CH₂CH₂Si(OCH₃)₃, C₇F₁₅CONHCH—CH₂CH₂Si(OCH₃)₃, C₈F₁₇CO₂CH₂CH₂CH₂Si(OCH₃)₃, C₈F₁₇—O—CF(CF₃) CF₂—O—C₃H₆SiCl₃, and C₃F₇—O—(CF(CF₃) CF₂—O)₂—CF(CF₃) CONH—(CH₂)₃Si(OCH₃)₃; and an organosilazane compounds such as hexamethyldisilazane, hexaphenyldisilazane, trisilazanc, cyclotrisilazane, and 1,1,3,3,5,5-hexamcthylcyclotrisilazanc.

A treatment amount of the silane coupling agent is preferably 0.01 parts by mass or more, more preferably 0.02 parts by mass or more, and still more preferably 0.10 parts by mass or more, and is preferably 5 parts by mass or less, and more preferably 2 parts by mass or less with respect to 100 parts by mass of the hollow silica. When two or more types of the silane coupling agents are used in combination, the above treatment amount means a total treatment amount of the plurality of types of the silane coupling agents.

Examples of the method for treating with the silane coupling agent include a dry method in which the silane coupling agent is sprayed onto untreated hollow silica 1 that is one before the surface treatment, and a wet method in which the hollow silica 1 is dispersed in a solvent and then a silane coupling agent is added to react with the hollow silica. (Here, the “hollow silica 1” refers to untreated hollow silica before the surface treatment.)

Note that the fact that the surface of the surface-treated hollow silica is treated with the silane coupling agent can be confirmed by detecting a peak due to a substituent of the silane coupling agent using IR. An adhesion amount of the silane coupling agent can be measured by an amount of carbon. The amount of carbon can be measured by a combustion method using a SUMIGRAPH NC-80 (manufactured by Sumika Chemical Analysis Service, Ltd.).

From a viewpoint of performing a uniform treatment, a wet treatment method is preferable as a surface treatment condition. A solvent used in this case may be a hydrocarbon organic solvent.

A value obtained by dividing a molecular weight of the silane coupling agent by the number of Si atoms contained in one molecule of the silane coupling agent is preferably 100 or more and 300 or less. The value corresponds to a molecular weight of a group to be bonded when the silane coupling agent is bonded to the silica particle surface. When the value is 100 or more, the volatility of the silane coupling agent can be reduced to prevent the silane coupling agent from evaporating during the reaction. When the value is 300 or less, steric hindrance is created to prevent the silanol group from remaining.

The value is preferably 100 or more, more preferably 150 or more, and still more preferably 180 or more. In addition, the value is preferably 300 or less, more preferably 270 or less, and still more preferably 260 or less.

When two or more types of the silane coupling agents are used in combination, the above value for each of the silane coupling agents is preferably 100 or more and 300 or less. Furthermore, in the surface treatment, a heating temperature after bringing the hollow silica 1 into contact with the silane coupling agent is preferably 50° C. to 200° C. When the heating temperature is high, a remaining percentage of the silane coupling agent is increased, and when the heating temperature is too high, partial decomposition begins, resulting in the regeneration of silanol groups. When the heating temperature is low, a reaction rate is reduced, the silanol groups are more likely to remain, and the peel strength of the resin, particularly after a high-temperature and high-humidity test, deteriorates. The heating temperature is more preferably 60° C. or higher, still more preferably 70° C. or higher, and most preferably 80° C. or higher. The heating temperature is more preferably 170° C. or lower.

In the surface treatment, a product A×B of a density A of the hollow silica 1 and a solvent charged amount B per gram of the hollow silica 1 is preferably 0.5 to 2.5. The product corresponds to a solvent charged amount per volume of the hollow silica 1, and when the product is 0.5 or more, a solvent amount enough to sufficiently cover a surface of the hollow silica 1 is ensured, and thus the silanol group is difficult to remain, and a decrease in the peel strength, particularly after the high-temperature and high-humidity test, can be prevented. When the product is 2.5 or less, a solvent amount to be distilled off is reduced, resulting in excellent productivity.

The product is preferably 0.5 or more, more preferably 0.8 or more, and most preferably 1.0 or more. The product is preferably 2.5 or less, more preferably 2.0 or less, and most preferably 1.5 or less.

The surface-treated hollow silica of the present invention preferably contains titanium (Ti) in a range of 30 ppm by mass to 1500 ppm by mass. A content of Ti is preferably 80 ppm by mass or more and more preferably 100 ppm by mass or more, and is preferably 1000 ppm by mass or less, and more preferably 500 ppm by mass or less. The content of Ti can be measured by inductively coupled plasma (ICP) emission spectrometry after adding perchloric acid and hydrofluoric acid to the silica, igniting the mixture, and removing silicon which is the main component.

Ti is a component that is optionally included in the production of the surface-treated hollow silica. In the production of the surface-treated hollow silica, if fine powder is generated due to cracking of silica particles, the fine powder adheres to a surface of a base particle, and a specific surface area of the particle is increased. By including Ti at the time of producing the surface-treated hollow silica, it is easy to perform densification during firing. Accordingly, it is difficult to crack during post-processing after firing, and thus, generation of the fine powder can be prevented, and the number of adhesive particles adhering to the surface of the silica base particles can be reduced, thereby preventing an increase in the specific surface area. By including 30 ppm by mass or more of Ti, it is easy to perform densification during firing, and thus, the generation of the fine powder due to cracking can be reduced, and in the case where a content of Ti is less than or equal to 1500 ppm by mass, the above-described effect can be obtained, an increase in the amount of the silanol group can be prevented and deterioration of the dielectric loss tangent can be prevented.

The surface-treated hollow silica of the present invention may include an impurity element other than titanium (Ti) as long as the effect of the present invention is not impaired. Examples of the impurity element include Na, K, Mg, Ca, Al, and Fe in addition to Ti.

A content of an alkali metal and an alkaline earth metal in the impurity element is preferably 2000 ppm by mass or less, more preferably 1000 ppm by mass or less, and still more preferably 200 ppm by mass or less in total. The content is preferably 1 ppm by mass or more, more preferably 2 ppm by mass or more, and still more preferably 5 ppm by mass or more in total.

### <Hollow Silica 1>

The hollow silica 1, that is, the untreated hollow silica before surface treatment, can be obtained by a known production method in the related art. Examples of such a production method include a template method in which a hollow structure is formed using a mold. In addition, commercially available hollow silica 1 may be used. The hollow silica 1 may be selected appropriately depending on the properties desired for the surface-treated hollow silica.

A density, a BET specific surface area, and a median diameter d50 of the hollow silica 1 generally correspond to a density, a BET specific surface area, and a median diameter d50 of the surface-treated hollow silica. Therefore, the characteristics of the hollow silica 1 may be selected appropriately based on the characteristics desired for the surface-treated hollow silica.

### <Resin Composition>

The surface-treated hollow silica of the present invention has excellent adhesiveness to the resin, and thus mixability with the resin composition is excellent.

The resin composition according to the present embodiment includes the surface-treated hollow silica of the present invention and the resin. A content of the surface-treated hollow silica in the resin composition is preferably 5 vol % to 70 vol %, more preferably 10 vol % to 60 vol %, still more preferably 15 vol % to 60 vol %, and most preferably 20 vol % to 60 vol %. When the content of the surface-treated hollow silica is 5 vol % or more, a sufficient reduction in dielectric constant can be obtained, and when the content is 70 vol % or less, adhesiveness between the resin composition and a metal substrate is maintained.

The resin may use one or two or more types of a polyamide resin such as an epoxy resin, a silicone resin, a phenol resin, a melamine resin, a urea resin, an unsaturated polyester resin, a fluororesin, a polyimide resin, a polyamide-imide resin, or a polyether imide; a polyester resin such as a polybutylene terephthalate or a polyethylene terephthalate; a polyphenylene ether resin, a polyphenylene sulfide resin, an ortho-divinyl benzene resin, an aromatic polyester resin, a polysulfone, a liquid crystal polymer, a polyethersulfone, a polycarbonate, a maleimide modified resin, an acrylonitrile butadiene styrene (ABS) resin, an acrylonitrile-acrylic rubber-styrene (AAS) resin, an acrylonitrile-ethylene-propylene-diene rubber-styrene (AES) resin, a poly tetrafluoroethylene (PTFE), a tetrafluoroethylene-perfluoroalkyl vinyl ether copolymer (PFA), a tetrafluoroethylene-hexafluoropropylene copolymer (FEP), and a tetrafluoroethylene-ethylene copolymer (ETFE). Since the dielectric loss tangent in the resin composition also depends on characteristics of the resin, the resin to be used may be selected in consideration of this factor.

The resin preferably includes a thermosetting resin. The thermosetting resins may be used alone or in combination. Examples of the thermosetting resin include an epoxy resin, a polyphenylene ether resin, a polyimide resin, a phenol resin, and an ortho-divinyl benzene resin. From viewpoints of adhesiveness, heat resistance, and the like, the thermosetting resin is preferably an epoxy resin, a polyphenylene ether resin, or an ortho-divinyl benzene resin.

From viewpoints of adhesiveness, dielectric characteristics, and the like, a weight average molecular weight of the thermosetting resin is preferably 1000 to 7000, more preferably 1000 to 5000, and still more preferably 1000 to 3000. The weight average molecular weight is determined by gel permeation chromatography (GPC) in terms of polystyrene.

A particle size distribution of the surface-treated hollow silica contained in the resin composition is preferably unimodal. The fact that the particle size distribution of the surface-treated hollow silica is unimodal can be confirmed from a matter that there is one peak in the particle size distribution according to a laser diffraction and scattering method.

The resin composition may contain an optional component other than the above resin and medium (for example, toluene, methyl ethyl ketone, methyl isobutyl ketone, and cyclohexanone). Examples of the optional component include a dispersion aid, a surfactant, and a filler other than silica particles.

### EXAMPLES

Hereinafter, the present invention will be described with reference to Examples, but the present invention is not limited thereto. In the following description, common components employ the same substance.

### <Hollow Silica A1>

Hollow silica A1 was prepared as follows.

### (Preparation of Emulsion)

To 1250 g of pure water, 4 g of an EO-PO-EO block copolymer (Pluronic F68 (registered trademark) manufactured by ADEKA Corporation) was added, followed by stirring until dissolution to obtain an aqueous solution. To the obtained aqueous solution, 42 g of n-decane having 4 g of sorbitan acid monooleate (IONET (registered trademark)S-80 manufactured by Sanyo Chemical Industries, Ltd.) dissolved was added, followed by stirring by a homogenizer manufactured by IKA until the entire liquid became uniform to prepare a crude emulsion.

The crude emulsion was emulsified under a pressure of 50 bar by using a high pressure emulsifier (LAB1000 manufactured by SMT CO., LTD.) to prepare an emulsion having an emulsion diameter of 1 μm.

### (Aging)

The obtained emulsion was left to stand at 40° C. for 12 hours.

### (First-stage Shell Layer Formation)

After standing, 23 g of a diluted sodium silicate aqueous solution (SiO₂ concentration of 10.4 vol %, Na₂O concentration of 3.6 vol %) and 2 M hydrochloric acid were added to 1300 g of the emulsion so as to have a pH of 2, followed by stirring while maintaining at 30° C., and a mixed liquid was obtained.

Next, while the mixed liquid was stirred, 1 M sodium hydroxide aqueous solution was dropped slowly to the mixed liquid so that the pH became 6, thereby obtaining an oil core-silica shell particle dispersion. The obtained oil core-silica shell particle dispersion was maintained and aged.

### (Second-stage Shell Layer Formation)

The oil core-silica shell particle dispersion was heated to 70° C., and 1 M sodium hydroxide aqueous solution was added slowly with stirring to adjust the pH to 9.

Next, 330 g of a diluted sodium silicate aqueous solution (SiO₂ concentration of 10.4 vol %, Na₂O concentration of 3.6 vol %) was gradually added together with 0.5 M hydrochloric acid so as to have the pH of 9.

The obtained suspension was maintained at 80° C. for 1 day and then cooled to room temperature to obtain a hollow silica precursor dispersion.

### (Filtration, Washing, Drying, and Firing)

The entire hollow silica precursor dispersion was neutralized with 2 M hydrochloric acid so as to have a pH of 2, and then filtered with quantitative filter paper 5C. Thereafter, 350 ml of ion-exchanged water of 80° C. was added thereto, followed by filtration under pressure again to wash a hollow silica precursor cake.

A cake obtained after the filtration was dried in a nitrogen atmosphere at 100° C. for 1 hour and then at 400° C. for 2 hours (temperature increase rate of 10° C./min) to remove organic components, thereby obtaining a hollow silica precursor.

The obtained hollow silica precursor was fired at 1050° C. for 1 hour (temperature increase rate of 10° C./min) to densify a shell, thereby obtaining hollow silica A1.

### <Hollow Silica A2>

Hollow silica A2 was obtained in the same manner as the hollow silica A1, except that a usage amount of the EO-PO-EO block copolymer was changed to 2 g and a usage amount of sorbitan monooleate was changed to 2 g.

### <Hollow Silica A3>

Hollow silica A3 was obtained in the same manner as the hollow silica A1, except that a usage amount of the EO-PO-EO block copolymer was changed to 10 g, sorbitan monooleate was not used, and a pressure in emulsification was changed to 100 bar.

### <Hollow Silica A4>

Hollow silica A4 was obtained in the same manner as the hollow silica A1, except that a firing condition for the hollow silica precursor was changed to 1100° C. for 1 hour (temperature increase rate of 10° C./min).

### <Hollow Silica A5>

Hollow silica A5 was obtained in the same manner as the hollow silica A1, except that a firing condition for the hollow silica precursor was changed to 800° C. for 1 hour (temperature increase rate of 10° C./min).

### (Surface Treatment)

In a 3.5 L planetary mixer (HIVIS MIX 3L-5, manufactured by PRIMIX Corporation), 200 g of hollow silica was placed. In addition, 1.4 g of a silane coupling agent listed in Table 1 was added to hexane, which was adjusted such that a product value of the density A of untreated hollow silica 1 and the solvent charged amount B per gram of the untreated hollow silica 1 was a value in Table 1, followed by stirring for 5 minutes with a magnetic stirrer to prepare a solution. The prepared solution was added in the planetary mixer containing the hollow silica, and nitrogen was introduced for 10 minutes while stirring at 60 rpm. A temperature was increased to 80° C. at a rate of 2° C./min while nitrogen was introduced and maintained at 80° C. for 1 hour, and then the mixture was allowed to cool to 50° C. and removed into the air to obtain surface-treated hollow silica. According to this procedure, the surface-treated hollow silica according to Examples 2 to 10 and 16 to 23 was obtained. In Example 1, the hollow silica A1 was used as is without surface treatment.

In Examples 11 to 15, except that the heating temperature was changed from 80° C. to temperatures listed in Table 1, surface-treated hollow silica was prepared in the same manner as in Example 1.

The surface-treated hollow silica was prepared in the same manner as in Example 1, except that the usage amount in Example 24 was changed to 0.1 g of the silane coupling agent listed in Table 1, in Example 25 was changed to 0.4 g of the silane coupling agent listed in Table 1, in Example 26 was changed to 5.0 g of the silane coupling agent listed in Table 1, and in Example 27 was changed to 14.0 g of the silane coupling agent listed in Table 1.

Hereinafter, the hollow silica in Example 1 and the surface-treated hollow silica in Examples 2 to 27 may be collectively referred to as the “hollow silica”.

The following measurements were conducted on the obtained hollow silica according to Examples 1 to 27. The results are shown in Table 1.

### (Measurement by Chromatography)

Regarding the hollow silica according to each of Examples, a symmetry coefficient and a peak area of an amine in chromatography were measured by the following method, and results were shown in Table 1.

The hollow silica was wet-packed into a stainless steel column with an internal diameter of 4.6 mm and a length of 100 mm, and this column was then loaded into a chromatography device (Prominence (manufactured by Shimadzu Corporation)) and was measured under the following conditions.
Eluent: MeOH/20 mM buffer solution of phosphoric acid (pH 7.0)=82/18
Flow rate: 0.5 mL/min
Temperature: 25° C.
Detector: UV at 254 nm
Sample: propranolol hydrochloride

An obtained peak was analyzed according to JIS K0124:2011 to obtain the peak area and the symmetry coefficient. Note that a peak area obtained when the same measurement was performed without packing the hollow silica was used as the theoretical value of the peak area. In Table 1, “-” in the symmetry coefficient S indicated that the amine was adsorbed to the hollow silica and could not be detected.

### (Method for Measuring Density of Hollow Silica)

The hollow silica used in each of Examples was dried under reduced pressure at 230° C. to completely remove water, thereby obtaining a sample. The density of the sample was measured using a dry pycnometer (AccuPyc II 1340 manufactured by Micromeritics Instrument Corporation). Measurement conditions were as follows. Results are shown in Table 1 as “Ar density”.

### (Measurement Conditions)

Sample cell: 10 cm³ cell
Sample weight: 1.0 g
Measurement gas: argon gas
Number of times of purge: 10 times
Purge processing packing pressure: 135 kPaG
Number of cycles: 10 times
Cycle packing pressure: 135 kPaG
Rate at which pressure equilibrium is terminated: 0.05 kPaG/min

### (Method for Measuring BET Specific Surface Area of Hollow Silica)

The hollow silica used in each of Examples was dried under reduced pressure at 230° C. to completely remove water, thereby obtaining a sample. Regarding this sample, the specific surface area was obtained by a multi-point BET method using a nitrogen gas in “TriStar II”, which is an automatic specific surface area and pore distribution measuring device manufactured by Micromeritics Instrument Corporation. The results are shown in Table 1.

### (Method for Measuring d50 of Hollow Silica)

The d50 of the hollow silica used in each of Examples was measured by a particle size distribution analyzer (MT3300EXII manufactured by MicrotracBEL Corp.) using a laser diffraction and scattering method. Specifically, the measurement was performed after dispersing secondary particles of the hollow silica by being irradiated with ultrasonic waves for 120 seconds, and the value at which the cumulative distribution of the obtained particle sizes reached 50% was defined as d50. The results are shown in Table 1.

### (Method for Measuring Bulk Density of Hollow Silica)

A bulk density of the hollow silica was measured by placing the hollow silica in a 100 cm³ graduated cylinder, tapping until the bulk remained constant, and then measuring a volume and mass in that case.

### (Measurement of Peel Strength, Dielectric Loss Tangent, and Relative Dielectric Constant of Resin Composition Using Hollow Silica)

### Example 1

In a planetary centrifugal mixer (Awatori Rentaro ARE-310, manufactured by Thinky Corporation), 25 parts by mass of polyphenylene ether resin, 50 parts by mass of butadiene-styrene random copolymer, 0.75 parts by mass of α,α′-di(t-butylperoxy)diisopropylbenzene, a certain part by mass of hollow silica A1 such that the hollow silica A1 has 40 vol % with respect to entire volume, and 50 parts by mass of toluene were placed, followed by mixing at 2000 rpm for 30 minutes to obtain a resin composition.

The obtained resin composition was vacuum dried at 120° C. for 1 hour, and then 5 g of the mixture was sampled and placed in a 80 mm square mold having a thickness of 0.3 mm, and low-profile copper foil (thickness: 18 μm, Rz: 3.5 μm, manufactured by Mitsui Kinzoku Co., Ltd., 3EC-M3-V-18) was laminated on top and bottom. A temperature of the obtained laminate was increased to 200° C. at a temperature increase rate of 5° C./min and maintained for 120 minutes at a pressure of 10 MPa for heat molding to obtain a resin-coated metal substrate. Regarding the obtained resin-coated metal substrate, peel strength between a cured product of a prepreg and the copper foil was measured in accordance with IPC-TM650-2.4.8. The peel strength is described as “peel (PPE)” in Table 1.

The peel strength after a high temperature and high humidity test was measured in the same manner after leaving the obtained resin-coated metal substrate in a constant temperature and humidity chamber set at 85° C. and 85% RH for 24 hours. In Table 1, the peel strength after high-temperature and high-humidity test was described as “high-temperature and high-humidity peel”.

The obtained resin-coated metal substrate was etched with an etching solution (H-1000A, manufactured by Sunhayato Corp.) and dried in an oven at 100° C. for 1 hour, and then a split-post dielectric resonator (SPDR)(manufactured by Agilent Technologies) was used to measure the relative dielectric constant and the dielectric loss tangent.

The obtained measurement results were summarized in Table 1.

### Examples 2 to 27

Except that the hollow silica A1 was changed to the surface-treated hollow silica shown in Table 1, the resin composition, the prepreg, and the resin-coated metal substrate were produced in the same manner as in Example 1, and measurements similar to those in Example 1 were carried out.

TABLE 1

| | | | | | | | | | High- |
|---|---|---|---|---|---|---|---|---|---|
| | Hollow silica | | | | | | | | temperature and |
| | | Ar | | | Bulk | Relative | Dielectric | Peel | high-humidity |
| | | density | BET | d50 | density | dielectric | loss | (PPE) | peel |
| | Type | g/cm³ | m²/g | μm | g/cm³ | constant | tangent | N/cm | N/cm |
| Example 1 | A1 | 0.65 | 12 | 1 | 0.08 | 2.2 | 0.005 | 3 | 1 |
| Example 2 | A1 | 0.65 | 12 | 1 | 0.08 | 2.2 | 0.0047 | 4 | 2 |
| Example 3 | A1 | 0.65 | 12 | 1 | 0.08 | 2.2 | 0.003 | 7 | 6 |
| Example 4 | A2 | 0.45 | 6 | 2 | 0.13 | 2.1 | 0.0025 | 8 | 7 |
| Example 5 | A3 | 1.00 | 60 | 7 | 0.20 | 2.5 | 0.004 | 7 | 5 |
| Example 6 | A4 | 1.50 | 10 | 9 | 0.40 | 2.7 | 0.0022 | 9 | 6 |
| Example 7 | A5 | 0.80 | 44 | 1 | 0.07 | 2.3 | 0.0038 | 6 | 4 |
| Example 8 | A1 | 0.65 | 12 | 1 | 0.08 | 2.2 | 0.0033 | 6 | 5 |
| Example 9 | A1 | 0.65 | 12 | 1 | 0.08 | 2.2 | 0.0023 | 6 | 3 |
| Example 10 | A1 | 0.65 | 12 | 1 | 0.08 | 2.2 | 0.0023 | 8 | 7 |
| Example 11 | A1 | 0.65 | 12 | 1 | 0.08 | 2.2 | 0.003 | 8 | 7 |
| Example 12 | A1 | 0.65 | 12 | 1 | 0.08 | 2.2 | 0.0031 | 8 | 7 |
| Example 13 | A1 | 0.65 | 12 | 1 | 0.08 | 2.2 | 0.0033 | 7 | 6 |
| Example 14 | A1 | 0.65 | 12 | 1 | 0.08 | 2.2 | 0.003 | 7 | 5 |
| Example 15 | A1 | 0.65 | 12 | 1 | 0.08 | 2.2 | 0.004 | 6 | 4 |
| Example 16 | A1 | 0.65 | 12 | 1 | 0.08 | 2.2 | 0.0038 | 6 | 3 |
| Example 17 | A1 | 0.65 | 12 | 1 | 0.08 | 2.2 | 0.003 | 6 | 6 |
| Example 18 | A1 | 0.65 | 12 | 1 | 0.08 | 2.2 | 0.003 | 6 | 5 |
| Example 19 | A1 | 0.65 | 12 | 1 | 0.08 | 2.2 | 0.003 | 7 | 6 |
| Example 20 | A1 | 0.65 | 12 | 1 | 0.08 | 2.2 | 0.003 | 7 | 6 |
| Example 21 | A1 | 0.65 | 12 | 1 | 0.08 | 2.2 | 0.003 | 7 | 6 |
| Example 22 | A1 | 0.65 | 12 | 1 | 0.08 | 2.2 | 0.0028 | 8 | 7 |
| Example 23 | A1 | 0.65 | 12 | 1 | 0.08 | 2.2 | 0.0035 | 7 | 5 |
| Example 24 | AI | 0.65 | 12 | 1 | 0.08 | 2.2 | 0.003 | 5 | 3 |
| Example 25 | A1 | 0.65 | 12 | 1 | 0.08 | 2.2 | 0.003 | 7 | 6 |
| Example 26 | A1 | 0.65 | 12 | 1 | 0.08 | 2.2 | 0.003 | 7 | 6 |
| Example 27 | A1 | 0.65 | 12 | 1 | 0.08 | 2.2 | 0.003 | 7 | 5 |

| | | | | | Ar | |
|---|---|---|---|---|---|---|
| | | | Surface treatment | | density * | |
| | | | | Molecular | solvent | |
| | Symmetry | | | weight/ | charged | Heating |
| | coefficient | Peak | | number | amount | temperature |
| | S | area | Coupling agent | of Si | per gram | ° C. |
| Example 1 | — | 0% | — | — | | |
| Example 2 | 10 | 50% | Vinyltrimethoxysilane | 190.3 | 0.39 | 80 |
| Example 3 | 1.05 | 100% | Vinyltrimethoxysilane | 190.3 | 1.17 | 80 |
| Example 4 | 1.02 | 100% | Vinyltrimethoxysilane | 190.3 | 0.972 | 80 |
| Example 5 | 1.25 | 97% | Vinyltrimethoxysilane | 190.3 | 1.188 | 80 |
| Example 6 | 1.18 | 100% | Vinyltrimethoxysilane | 190.3 | 1.188 | 80 |
| Example 7 | 1.36 | 96% | Vinyltrimethoxysilane | 190.3 | 1.188 | 80 |
| Example 8 | 3 | 70% | Vinyltrimethoxysilane | 190.3 | 0.65 | 80 |
| Example 9 | 1.02 | 100% | Vinyltrimethoxysilane | 190.3 | 1.56 | 80 |
| Example 10 | 1.02 | 100% | Vinyltrimethoxysilane | 190.3 | 2.6 | 80 |
| Example 11 | 1.02 | 100% | Vinyltrimethoxysilane | 190.3 | 1.17 | 120 |
| Example 12 | 1.02 | 100% | Vinyltrimethoxysilane | 190.3 | 1.17 | 170 |
| Example 13 | 1.09 | 97% | Vinyltrimethoxysilane | 190.3 | 1.17 | 250 |
| Example 14 | 1.33 | 95% | Vinyltrimethoxysilane | 190.3 | 1.17 | 60 |
| Example 15 | 2.3 | 78% | Vinyltrimethoxysilane | 190.3 | 1.17 | 30 |
| Example 16 | 1.4 | 92% | 1,1,1,3,3,3-Hexamethyldisilazane | 80.7 | 1.17 | 80 |
| Example 17 | 1.18 | 100% | Octyltrimethoxysilane | 234.41 | 1.17 | 80 |
| Example 18 | 1.12 | 100% | Propyltrimethoxysilane | 164.28 | 1.17 | 80 |
| Example 19 | 1.15 | 100% | N-phenyl-3-aminopropyltrimethoxysilane | 255.4 | 1.17 | 80 |
| Example 20 | 1.07 | 100% | Vinyltrimethoxysilane/N-phenyl-3- | 190.3/255.4 | 1.17 | 80 |
| | | | aminopropyltrimethoxysilane | | | |
| Example 21 | 1.08 | 100% | 3-Aminopropyltrimethoxysilane/N- | 179.29/255.4 | 1.17 | 80 |
| | | | phenyl-3-aminopropyltrimethoxysilane | | | |
| Example 22 | 1.12 | 100% | 3-Methacryloxypropyltrimethoxysilane | 248.4 | 1.17 | 80 |
| Example 23 | 2 | 82% | 8-Methacryloxyoctyltrimethoxysilane | 318.5 | 1.17 | 80 |
| Example 24 | 1.05 | 100% | Vinyltrimethoxysilane | 190.3 | 1.17 | 80 |
| Example 25 | 1.05 | 100% | Vinyltrimethoxysilane | 190.3 | 1.17 | 80 |
| Example 26 | 1.05 | 100% | Vinyltrimethoxysilane | 190.3 | 1.17 | 80 |
| Example 27 | 1.05 | 100% | Vinyltrimethoxysilane | 190.3 | 1.17 | 80 |

It was found that the surface-treated hollow silica according to each of Examples 3 to 27 had higher peel strength and higher peel strength after high-temperature and high-humidity test than those of Comparative Examples (Examples 1 and 2), and were excellent in both adhesiveness to resin and the reliability thereof. 5 On the other hand, the hollow silica of Example 1 and the surface-treated hollow silica of Example 2, which were Comparative Examples, had lower peel strength and a significant decrease in the peel strength after high-temperature and high-humidity test, and thus the adhesiveness to resin and the reliability thereof were poor.

Although the present invention has been described in detail with reference to specific aspects, it is apparent to those skilled in the art that various changes and modifications can be made without departing from the spirit and scope of the present invention.

Note that the present application is based on a Japanese patent application (Japanese Patent Application No. 2023-099441) filed on Jun. 16, 2023, the entire contents of which are incorporated herein by reference.

1. Surface-treated hollow silica, having a peak area of an amine in chromatography being 70% or more of a theoretical value, and having a symmetry coefficient S of 8 or less in the chromatography.

2. The surface-treated hollow silica according to claim 1, having a density of 0.25 g/cm³ to 2.00 g/cm³.

3. The surface-treated hollow silica according to claim 1, having a BET specific surface area of 1 m²/g to 100 m²/g.

4. The surface-treated hollow silica according to claim 1, having a median diameter (d50) of 0.1 μm to 10 μm.

5. A method for producing the surface-treated hollow silica according to claim 1, the method comprising:
performing a surface treatment on untreated hollow silica, wherein
a value obtained by dividing a molecular weight of a silane coupling agent used in the surface treatment by the number of Si atoms contained in one molecule of the silane coupling agent is 100 to 300.

6. The method for producing the surface-treated hollow silica according to claim 5, wherein
the surface treatment comprises bringing the untreated hollow silica into contact with the silane coupling agent, followed by heating at a temperature of 50° C. to 200° C.

7. The method for producing the surface-treated hollow silica according to claim 6, wherein
a solvent is used during the contact, and
a product A×B of a density A of the untreated hollow silica and a solvent charged amount B per gram of the untreated hollow silica is 0.5 to 2.5.

8. A resin composition comprising:
the surface-treated hollow silica according to claim 1; and
a resin.
